(19) United States
(12) Patent Application Publication
(10) Pub. No.: US 2026/0228420 A1
(43) Pub. Date: Aug. 6, 2026

(54) SYSTEMS AND METHODS FOR TRANSCRIPT KEYWORDS

(71) Applicant: JPMORGAN CHASE BANK, N.A., New York, NY (US)

(72) Inventors: Devin MOORE, Columbus, OH (US); Udayalakshmi RAMAN, Hyderabad (IN)

(21) Appl. No.: 19/465,988

(22) Filed: Jan. 30, 2026

(30) Foreign Application Priority Data
Feb. 3, 2025 (IN) 202511008649

(51) Int. Cl. G06F 40/169; G06F 40/103; G06F 40/30; G10L 15/26

(52) U.S. Cl. CPC G06F 40/169; G06F 40/103; G06F 40/30; G10L 15/26

(57) ABSTRACT

In some embodiments, the techniques described herein relate to a method including: receiving an audio or video file in real-time or from a database; executing a closed caption service application programming interface (“API”), generating a closed caption feed, conducting a word lookup for a word and/or phrase of the closed caption feed, generating a word link to a database for the word and/or phrase of the closed caption feed, seeding a regular expression with an insert link with a related word and/or a related phrase, and generating the annotated feed based on the insert link

### RELATED APPLICATIONS

This application claims the benefit of Indian Provisional Patent Application Ser. No. 202511008649, filed February 3, 2025. The disclosure of this application is hereby incorporated, by reference, in its entirety.

### BACKGROUND

### 1. Field of The Invention

Embodiments generally relate to systems and methods for generating or enhancing text of transcripts including of specific keywords.

### 2. Description of the Related Art

Conventional methods may include transcription of audio or video files that may be performed with a speech recorder and certain software applications. Some applications may generate new notes based on a real-time transcription. However, current systems display text without any adornment or decoration. The adornment or decoration must be painstakingly added by manual labor after the text has been generated. The additions are often or mostly prone to human error, difficult to organize, and inconsistent. Improved systems consistent with the present disclosure will resolve these issues.

Existing captioning pipelines may produce raw text buffers with limited contextual awareness and minimal structural formatting, often lacking mechanisms to link transcript content to curated knowledge repositories or to apply consistent rules for expansions, corrections, and formatting. Manual editing workflows introduce latency, cost, and variability, and they fail to support dynamic updates when topics evolve within an ongoing stream. The disclosed systems may integrate machine learning topic detection, semantic word and phrase validation, rule-based regular expressions, and indexed links to external databases to create annotated feeds that remain coherent as the stream progresses, thereby reducing manual intervention while improving accuracy and consistency.

### SUMMARY

Exemplary embodiments provide systems and methods for generating or enhancing text of transcript. According to one embodiment, a method may include receiving an audio or video file in real-time or from a database; executing a closed caption service application programming interface (“API”), generating a closed caption feed, conducting a word lookup for a word and/or phrase of the closed caption feed, generating a word link to a database for the word and/or phrase of the closed caption feed, seeding a regular expression with an insert link with a related word and/or a related phrase, and generating the annotated feed based on the insert link.

Disclosed methods may include receiving audio or video, generating closed captions, transmitting portions to a machine learning engine, determining a topic using semantic similarity, conducting word lookups against a database, generating word links with indexes, seeding a regular expression with insert links tied to related words or phrases, and generating an annotated feed by inserting adornments. Disclosed methods may include caching stream segments, updating captions on segment boundaries, and supporting near real-time processing. Disclosed methods may include computing semantic similarity for multi-word phrases and selecting a topic when a score exceeds a threshold. Disclosed methods may include detecting transcription errors, semantically searching candidate replacements for single words and multi-word phrases, and updating the annotated feed before seeding.

Disclosed methods may include assigning pointers to database records and storing definitions, synonym sets, topic identifiers, color codes, and hyperlink targets. Disclosed methods may include encoding insert links as linked-list nodes with type, start, end, and priority and resolving overlaps using priority. Disclosed methods may include applying adornments, highlighting, underlining, italicizing, bolding, and inserting titles, headers, emojis, images, and hyperlinks. Disclosed methods may include selecting a color palette progression and applying distinct color codes to topics and subtopics. Disclosed methods may include encoding topic-specific search patterns in regular expressions, replacing matches with formatted strings including insert links, and updating formats when topics change. Disclosed methods may include updating annotations, expanding acronyms, appending parentheticals, and converting spelled-out numbers to numerals using rule sets. Disclosed methods may include generating stream frames with timestamps, text buffers, and insert link lists and revising prior frames when topics update.

Disclosed methods may include accessing an external cloud database and a local cache and synchronizing the cache on misses. Disclosed methods may include detecting subtopics using hierarchical clustering of embeddings and seeding a second regular expression with distinct subtopic adornments. Disclosed methods may include applying spacing and header formatting, transforming phrases into structural elements, and indexing elements for navigation. Disclosed methods may include computing confidence scores using signal quality and transcription certainty, applying insert links when scores exceed thresholds, and flagging low-confidence locations for review.

Embodiments consistent with the present disclosure include a system including one or more processors and one or more storage devices storing instructions that when executed by one or more processors, cause the processor to perform one or more steps of the methods disclosed herein. Embodiments consistent with the present disclosure include a computer processing system, computer, or server, including: a memory configured to store instructions such as a non-transitory computer-readable storage medium; and a hardware processor operatively coupled to the memory for executing the instructions to perform one or more steps of the methods disclosed herein.

### BRIEF DESCRIPTION OF THE DRAWINGS

In order to facilitate a fuller understanding of the present invention, reference is now made to the attached drawings. The drawings should not be construed as limiting the present invention but are intended only to illustrate different embodiments and embodiments.

FIG. 1 is a block diagram of a system for generating or enhancing text of transcripts, in accordance with embodiments.

FIG. 2 is a method for generating or enhancing text of transcripts, in accordance with embodiments.

FIG. 3 is a block diagram of a computing device for implementing certain embodiments of the present disclosure.

### DETAILED DESCRIPTION

Embodiments generally relate to systems and methods for generating or enhancing text of transcripts. The present disclosure relates to computer-implemented systems and methods for generating or enhancing transcript text from audio and video sources. More particularly, the disclosure addresses automated techniques that may analyze closed caption streams, detect topics and subtopics, and apply structured annotations and visual adornments to improve readability, navigability, and/or semantic clarity of transcripts produced in real time or in post-processing.

Conventional systems and methods include generating a transcript from an audio or video file or source in real time or during post processing. Such systems and methods may use artificial intelligence to identify words or phrases from the audio or video file or source. Current systems may generate a summary or notes from the transcript by associating the transcript. Current systems may be prone to mistakes and hallucinations, may fail to focus on and identify key points, and/or may have no way to enhance or generate adorned text. The disclosed systems may reduce human editing effort, may increase correctness and consistency, and/or may improve readability and navigability of transcript outputs.

Systems and methods consistent with the present disclosure may include receiving an audio or video file in real time or from a database, may execute a closed caption service application programming interface, may generate a closed caption feed, may conduct a word lookup for a (e.g., each) word and phrase of the closed caption feed, may generate a word link to a database for the (e.g., each) word and phrase of the closed caption feed, may seed a regular expression with an insert link with a related word and a related phrase, and/or may generate the annotated feed based on the insert link. The systems may operate in stream and batch modes, may support near real-time processing, and/or may deliver adorned text continuously.

The closed caption service application may cache audio or video in contiguous segments of predetermined duration, may update the closed caption feed on segment boundaries, and may enable predictable latency for topic detection and annotation updates. The application programming interface service may transmit portions of the closed caption feed to a machine learning engine, which may determine a topic based on semantic similarity among located keywords and phrases. The machine learning engine may compute semantic similarity scores for at least four consecutive words grouped as phrases, may select topics when scores exceed thresholds, and/or may detect subtopics using hierarchical clustering of keyword embeddings. The machine learning engine may compute confidence scores based on signal quality and transcription certainty, may apply insert links when the confidence score exceeds a threshold, and may flag locations for deferred review. The approach may improve topical coherence, may reduce hallucinations, and/or may enable adaptive corrections while content streams.

The word search module may conduct lookups against a local cache and an external database hosted in a cloud environment. The module may synchronize the local cache with the external database on cache miss events for the closed caption feed. The expression module may generate word links for each word and phrase, may assign pointers to records or portions of records, and may reference definitions, synonym sets, topic identifiers, color codes, and/or hyperlink targets. The word link may include an index identifier to support efficient retrieval and navigation. The annotated feed may include frames with timestamps, text buffers, and lists of insert links applied to each buffer, and the closed caption service application may revise insert links in prior frames when the machine learning engine updates the topic. The system may deliver consistent annotations, may maintain alignment across segments, and may support auditability of changes.

The insert link may be encoded as a node in a linked list, may include an adornment type, a start index, an end index, and a priority value, and may resolve conflicts among overlapping nodes by applying the priority value. The regular expression may encode search patterns that match topic-specific phrases and may replace matched phrases with formatted strings comprising the original text and the insert link. The closed caption service application may update the formatted string when topics change in subsequent segments of the closed caption feed. The system may apply adornments comprising highlighting, underline, italics, bold, title formatting, section header formatting, insertion of emojis, insertion of images, and insertion of hyperlinks. The application may select a color palette progression to visually distinguish consecutive topics and subtopics, may apply distinct color codes sequentially, and may enhance visual parsing of complex discussions.

The system may correct transcription errors through semantic search for candidate replacements for single words and multi-word phrases, may update the annotated feed with corrected text prior to seeding regular expressions, and/or may reduce error rates introduced by noisy signals or ambiguous pronunciation. The system may update previously inserted annotations, may expand acronyms and may append parenthetical acronyms, may convert spelled-out numbers to numeric representations based on rule sets retrieved via word links, and/or may enforce consistent style guidelines. The closed caption service application may apply spacing formatting and header formatting to transform phrases designated as title headers or section headers into structural elements, may index structural elements via index identifiers, and/or may enable navigation across topics and subtopics within the annotated feed. The approach may improve clarity, may support hierarchical organization, and/or may provide efficient access to key segments.

The computing architecture may include processors executing software modules for the application programming interface service, machine learning engine, word search module, expression module, and/or database access. The architecture may operate in cloud, hybrid, or on-premises environments, may support distributed processing and memory, and/or may enable scalable throughput across concurrent streams. The disclosed systems may reduce manual labor required for post-production editing, may improve consistency of annotations, may increase accuracy through semantic validation, may provide dynamic topic-aware formatting, and/or may deliver higher-quality transcripts that may drive improved comprehension, searchability, and downstream analytics.

The disclosed systems may provide measurable benefits including reduced end-to-end processing time, reduced error rates, increased annotation coverage, improved user experience through structured and color-coded topics, and/or improved maintainability via indexed links and rule-based transformations. The systems may enable near real-time responsiveness to topic changes, may support continuous quality updates across frames, and/or may provide a reliable mechanism to integrate external knowledge sources through the word link framework. The systems may align with accessibility requirements, may enhance caption utility for diverse audiences, and/or may strengthen content engagement through intuitive adornments.

The disclosed systems may be implemented with modular components, may allow incremental deployment of machine learning models and rule sets, and/or may support customization of adornment policies for domains such as education, enterprise meetings, and media production. The systems may integrate with existing caption pipelines, may expose interfaces for third-party databases and style guides, and/or may provide monitoring tools to track confidence, errors, and annotation density. The resulting annotated transcripts may deliver improved semantic fidelity, navigable structure, and/or visually coherent formatting that may transform raw captions into high-value content assets.

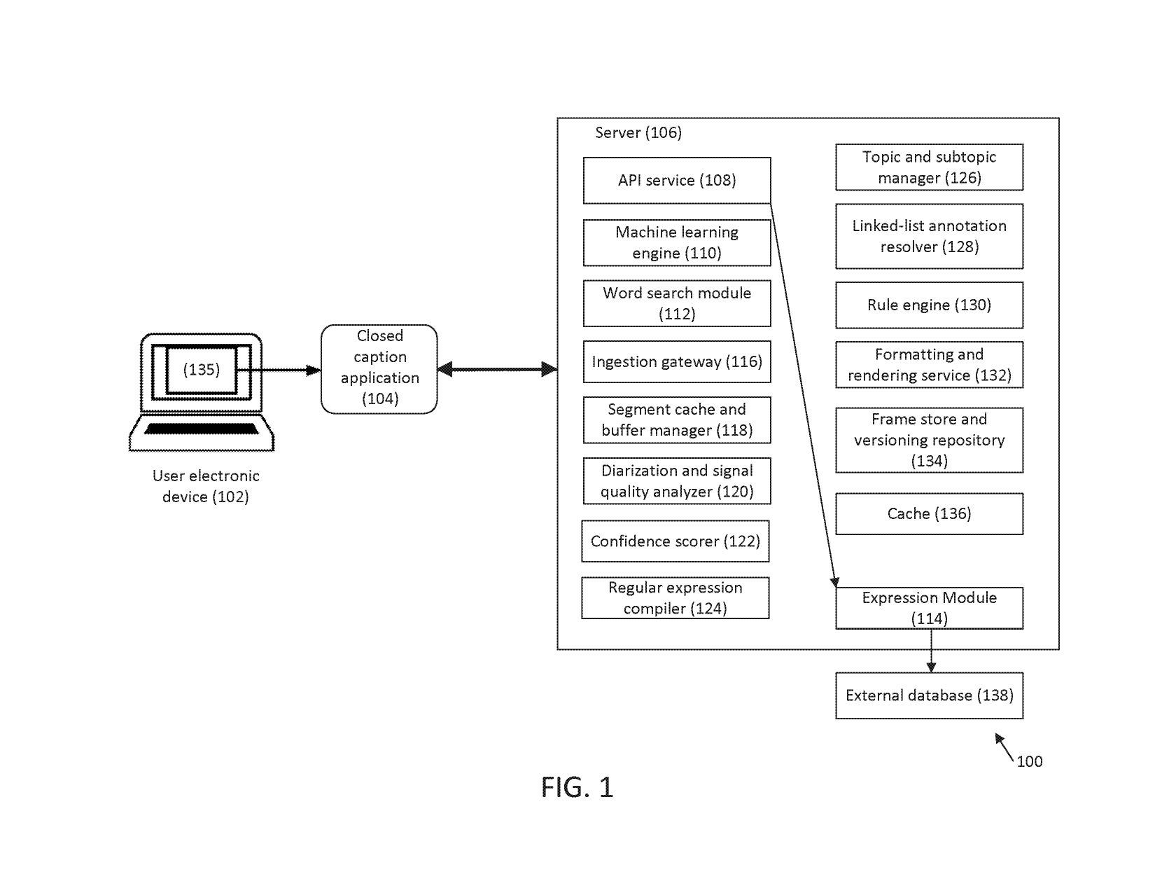

FIG. 1 is a block diagram of a system for identity proofing, in accordance with embodiments.

System 100 may include a user electronic device 102 executing a closed caption application 104 available through a user interface 135, a server 106 comprising a network or computer including a processor executing one or more software modules and a memory for storing data accessible by the one or more software modules and instructions to execute the one or more software modules. The one or more software modules may include one or more of an application programming interface (“API”) service 108, a machine learning engine 110, a word search module 112, an expression module 114, an ingestion gateway 116, a segment cache and buffer manager 118, a diarization and signal quality analyzer 120, a confidence scorer 122, a regular expression compiler 124, a topic and subtopic manager 126, a linked-list annotation resolver 128, a rule engine 130, a formatting and rendering service 132, a frame store and versioning repository 134, a cache 136, and an external database 138.

The server 106 may be a server. The server may be part of an institution backend. The server may be part of a cloud-based server. The server may be a computer. In some embodiments, the server 106 may include one or more databases referenced by one or more of the software modules.

In accordance with embodiments, user electronic device 102 may be a user electronic device such as a personal communication device (e.g., tablet, phone), computer workstation, laptop, or other electronic processing device in a closed caption application 104 and/or server 106. User electronic device 102 may be configured to interact with closed caption application 104 through user interface 135. For instance, user electronic device 102 may include a client application that allows a user of user electronic device 102 to interact with closed caption application 104. User interface 135 may include a graphical user interface to receive inputs and/or display information to the user. User interface 135 and/or closed caption application 104 may comprise one or more instructions executed by one or more processors of user electronic device 102. Closed caption application 104 may be a software production application provided by a service organization. In an exemplary aspect, closed caption application 104 may be an environment management application or system.

In some embodiments, closed caption application 104 may include an application programming interface (“API”) request (e.g., call) to communicate with server 106 to generate a transcript of a target audio or video file or stream (e.g., in real-time from a speaker or camera in operable communication with user electronic device 102). The audio or video file may be stored on a local database, a private cloud, a public cloud, and/or a hybrid cloud. In some embodiments, closed caption application 104 may respond to an API call with adorned text, a transcript, a transcript with adorned text and/or one or more insert links as discussed further herein. The closed caption application 104 may edit a stream as it receives and/or generate more transcript from the audio or video source such as revising previous adornment and/or generating new adornment based on a new understanding of a topic, phrase, and/or word in the transcript.

In some embodiments, closed caption application 104 may receive an audio or video file in real-time or from a database such as a memory of user electronic device or stored on a cloud. Closed caption application 104 may execute a closed caption service application programming interface (“API”) based on the audio or video file or stream. Closed caption application 104 may send a word or phrase to the server 106 for processing. The server 106 may include an API service 108 that receives the API call from the closed caption application 104. API service 108 may pass the word, phrase, or text to a machine learning engine 110. The machine learning engine 110 may determine a topic determined based on semantic similarity of more than one located keywords of the word, phrase, or text. The closed caption application 104 may generate a closed caption feed from the audio or video file and/or stream. The word, phrase, and/or text passed to server 106 may be based on the closed caption feed. A word search module 112 may conduct a word lookup for a (e.g., each) word and/or phrase of the closed caption feed. An expression module 114 may generate a word link to a database for the (e.g., each) word and/or phrase of the closed caption feed. The closed caption application 104 may seed a regular expression with an insert link with a related word and/or a related phrase. The closed caption application 104 may generate the annotated feed based on the insert link.

System components of FIG. 1 may reflect the claimed functionality and support a complete implementation may include an ingestion gateway 116 that may be a media input interface that may accept live streams and batch files, may normalize codecs, and may emit segmentized audio/video to the closed caption application. A segment cache and buffer manager 118 may include a component that may cache contiguous segments, may manage timestamps, and/or may expose segment boundaries for near real-time processing. Diarization and signal quality analyzer 120 may detect speaker changes, may compute acoustic features, and/or may provide signal quality metrics used in confidence scoring. Confidence scorer 122 may compute confidence scores per frame and per insert link based on signal quality and transcription certainty and may drive conditional application of annotations. Regular expression compiler 124 may generate and update topic-specific and subtopic-specific patterns and may handle replacement templates for formatted strings.

Topic and subtopic manager 126 may include a controller that may maintain current topic and subtopic states, may manage hierarchical clustering outputs, and/or may provide a topic stack to downstream modules. Linked-list annotation resolver 128 may manage nodes for insert links, may resolve overlaps using priority values, and/or may merge adjacent compatible nodes. Rule engine 130 may apply numeric conversion, acronym expansion, style guides, spacing, and/or header formatting based on rule sets retrieved via word links. Formatting and rendering service 132 may apply adornments, color palettes, and/or structural formatting to produce the annotated feed frames. Frame store and versioning repository 134 may persist frames, insert links, change logs, and/or snapshots, and may enable rollback and historical synchronization. Cache 136 may store recent database entries, rule sets, and/or embeddings, and may synchronize with the external database on cache miss events.

In some embodiments, an embeddings service (not shown) may compute and store keyword and phrase embeddings used for semantic similarity and hierarchical clustering. The embeddings service may function as a specialized subsystem that computes, stores, and serves vector representations of words, phrases, and contextual segments to enable semantic similarity, topic detection, and hierarchical clustering within the captioning pipeline. The service may operate online for low-latency streams and offline for batch processing and may expose interfaces for embedding generation, retrieval, update, and diagnostics. In some embodiments, the embeddings service may ingest tokens from the closed caption feed and may normalize inputs through text preprocessing steps that may include lowercasing, punctuation handling, stop-word filtering, lemmatization, and/or language detection. The service may construct phrase-level inputs by sliding windows over the text buffer, for example at least four consecutive words, and may generate contextual embeddings using transformer-based language models that may be fine-tuned for conversational or broadcast domains. The service may maintain multiple embedding spaces, for example word-level, phrase-level, and segment-level embeddings, and may select an appropriate space based on the task, such as single-word correction or multi-word topic inference.

In some embodiments, the embeddings service may compute similarity scores using cosine similarity or distance metrics that may be calibrated for each embedding space. The embeddings service may provide a semantic lookup that may return nearest neighbors for a token or phrase within a constrained vocabulary or knowledge domain retrieved via word links. The embeddings service may support hierarchical clustering by aggregating embeddings over time windows and may produce dendrogram structures that may identify topics and subtopics. In some embodiments, the clustering outputs may be streamed to the topic and subtopic manager 126, which may maintain a topic stack and may drive regular expression compilation for topic-specific patterns.

In some embodiments, the embeddings service may support correction workflows. The embeddings service may evaluate candidate replacements for single words by comparing embeddings against the local context window and may select replacements that may maximize contextual coherence. The embeddings service may evaluate phrases to correct grammar or transcription by scoring candidate expansions against embeddings derived from a larger context buffer. The selected candidates may be passed to rule engine 130 for normalization and style enforcement.

In some embodiments, the embeddings service may integrate with the confidence scoring service. The embeddings service may compute embedding stability metrics, for example variance of embeddings within a short temporal window, and may provide features that may correlate with language model perplexity and acoustic uncertainty. These features may contribute to confidence scores for insert links and may inform whether annotations may be applied immediately or flagged for deferred review.

In some embodiments, the embeddings service may implement a storage layer (e.g., frame store and versioning repository 134, cache 136) that may persist embeddings, metadata, and/or provenance. The storage layer may index embeddings by token identifiers, phrase hashes, frame timestamps, and/or topic identifiers. The embeddings service may maintain versioned embeddings tied to model versions and may allow rollback when model updates produce unacceptable drift. The storage layer may provide fast approximate nearest neighbor search using vector databases that may support sharding and replication for scalability.

In some embodiments, the embeddings service may expose APIs that may include endpoints for embedding generation, similarity search, batch updates, and/or diagnostics. The diagnostics endpoints may return embedding quality measures such as norm distributions, neighborhood coherence, and/or drift indicators. The service may log feature usage and may support telemetry that may track latency, cache hit rates, and/or the distribution of similarity scores across topics.

In some embodiments, the embeddings service may include a cache 136 that may store frequently requested embeddings and neighborhood results. The cache 136 may be populated through a prefetch strategy that may anticipate upcoming tokens based on sliding windows and topic predictions. The cache 136 may synchronize with the external database when vocabulary changes occur and/or when new rule sets introduce domain-specific terms.

In some embodiments, the embeddings service may support domain adaptation. The service may fine-tune base language models using curated corpora for specific domains, for example education, enterprise meetings, media production, and technical conferences. The service may store domain-specific adapters and may switch adapters dynamically based on detected topic identifiers returned from the machine learning engine.

In some embodiments, the embeddings service may include robustness measures to handle noisy inputs. The service may implement sub-word tokenization to tolerate misspellings, may compute character-level embeddings for uncertain tokens, and/or may fuse multiple embedding signals, for example word-piece and phonetic embeddings derived from audio cues. The fusion may produce composite embeddings that may improve resilience to transcription errors when referenced by word search module 112.

The embeddings service may communicate with rule engine 130 and/or expression module 114 to attach embedding-derived features to word links, such as topic affinity scores, synonym cluster identifiers, and/or ambiguity flags. These features may guide adornment choices, for example emphasizing high-affinity topic phrases with bold and underline or differentiating subtopics with italics and distinct color codes. The embeddings service may provide signals that may trigger acronym expansion and/or numeric conversion when semantic context suggests a formal or technical style.

In some embodiments, the embeddings service may enable analytics and search. The service may index frames by topic embeddings and may expose query capabilities that may retrieve segments similar to a given phrase and/or concept. The service may support cross-document similarity that may link related sessions and/or may provide navigation features in the annotated feed that may jump between semantically related passages.

In some embodiments, the embeddings service may reduce hallucinations by enforcing semantic consistency, may improve topic focus by clustering related content, may accelerate correction workflows with context-aware candidate selection, and/or may enable dynamic, topic-aware adornments that may increase readability and navigability. The service may operate efficiently at stream scale through caching, approximate neighbor search, and/or distributed processing, and may maintain high reliability through versioning, telemetry, and/or human-in-the-loop feedback integration.

In some embodiments, a monitoring and telemetry module (not shown) may collect metrics such as latency, error rates, confidence distributions, and/or adornment density and may expose dashboards. In some embodiments, a human-in-the-loop review interface such as a user electronic device may allow a reviewer console that may receive flagged frames and/or may accept corrections that are fed back into rule sets and thresholds.

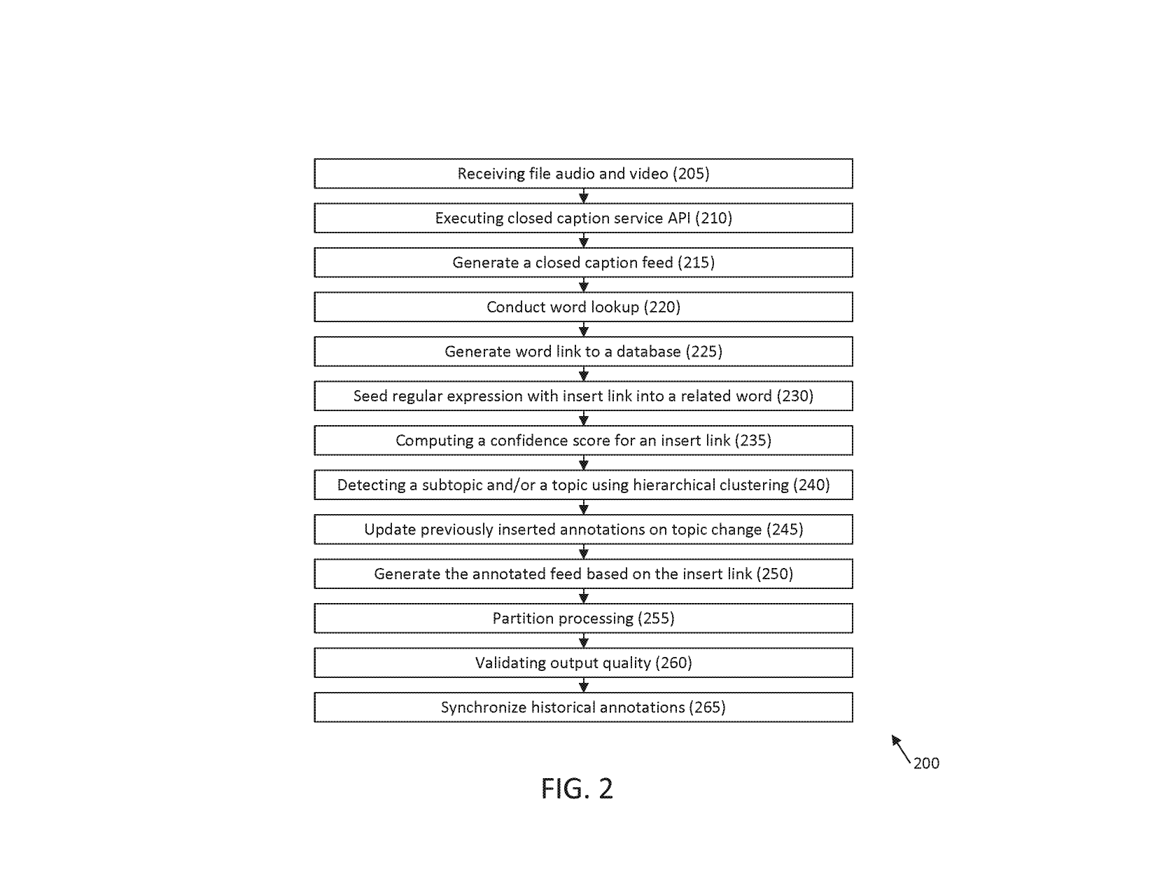

FIG. 2 is a method for an enhanced secrets manager, in accordance with some embodiments. Method 200 may be stored as a list of instructions stored on a memory that when executed by one or more processors cause the one or more processors to perform the method.

205 may include receiving, by a closed caption service application executed by one or more processors, an audio or video file in a batch or in real time or from a database. The real-time audio or video file may be received as a feed that may be cached in contiguous segments of predetermined duration. The closed caption service application may pull segments periodically, for example every half second, to support near real-time processing with predictable latency. The application may tag each segment with timestamps and quality indicators that may guide downstream confidence scoring.

210 may include executing, by the closed caption service application, a closed caption service application programming interface. The API may orchestrate transmission of portions of the closed caption feed to a machine learning engine, a word search module, and/or an expression module. The API may batch requests by segment boundaries and may maintain an index map between the incoming audio and/or video positions and the generated text buffers. Audio and/or video positions may be time-referenced locations within the source media stream that map portions of the media to corresponding transcript text. The audio and/or video positions may include timestamps measured from the start of the file or stream, for example in milliseconds or timecode, frame indices for video, for example frame number 12,345 at 30 fps, sample indices for audio, for example sample 2,400,000 at 48 kHz, segment boundaries used by the system, for example the start and end times of a cached half-second chunk, and/or cue points or markers created during processing, for example speaker-change markers or topic-change markers with precise times. The audio and/or video positions may be used to align text buffers and insert links with the underlying media, to support accurate playback, navigation, revision of past frames, and synchronization of adornments with spoken content. They may also guide confidence scoring and batching by segment boundaries, ensuring deterministic mapping between media and annotated text.

215 may include generating, by the closed caption service application or an artificial intelligence agent executed by the one or more processors, a closed caption feed. The feed may be produced as a stream comprising a sequence of frames, each frame including a timestamp, a text buffer, and/or a list of insert links applied to the text buffer. The closed caption service application may revise insert links in prior frames when the machine learning engine updates the topic and may propagate edits backward and forward within a configurable window.

220 may include conducting, by the closed caption service application or the artificial intelligence agent executed by the one or more processors, a word lookup for each word and phrase of the closed caption feed. The word lookup may reference an external database hosted in a cloud environment and a local cache. The word search module may synchronize the local cache with the external database based on cache miss events and may compress frequently accessed entries using domain-specific codecs. The lookup results may include one or more of a definition, a synonym set, a topic identifier, a color code, a hyperlink target, and a rule set for numeric conversion and acronym expansion.

225 may include generating, by the closed caption service application, a word link to a database for a (e.g., each) word and phrase of the closed caption feed. The word link may include an index identifier that may enable deterministic retrieval and navigation. The word link may include a pointer to a record and/or a portion of a record and may encode version metadata to allow rollback if a later topic update invalidates a prior association. The expression module may package the word link with formatting directives and rule references that may be applied downstream.

230 may include seeding, by the closed caption service application, a regular expression with an insert link with a related word and a related phrase. The regular expression may be a search pattern that may be used for searching, matching, and/or replacing text within strings and may include topic-specific tokens that may adapt when the topic changes in subsequent segments. The insert link may include adding a node to a linked list, the node may encode an adornment type, a start index, an end index, and/or a priority value. The related word and phrase may be determined based on the word and phrase of the closed caption feed and may be refined using semantic similarity computed by the machine learning engine. A single word may be semantically searched to ensure correction of transcription and spelling. At least four consecutive words grouped as a phrase may be semantically searched to correct transcription, grammar, and/or misspelling errors. The insert link may include adornment such as highlighting, bold, underline, italics, adding an emoji, adding a hyperlink, adding an image, and/or formatting a word and/or phrase as a title or section header with spacing. The related word and/or phrase may be selected using topic and subtopic detection produced by hierarchical clustering of keyword embeddings.

The insert link may accent annotations, may accompany them, and/or may replace an existing annotation depending on an edit type. The edit type may change a number representation, for example converting “one” to “1” or the reverse, and may expand acronyms with optional parenthetical retention, for example expanding “AKA” to “also known as” or “ABC” to “already being consumed.” The closed caption service application may select a color palette progression to visually distinguish consecutive topics and subtopics and may apply distinct color codes sequentially. The application may use highlighting and/or may assign adornment styles to distinguish topics using bold and underline and subtopics using italics. The linked-list nodes may resolve overlaps by applying the priority value and may merge compatible adjacent nodes for compact rendering.

235 may include computing, by the machine learning engine, a confidence score for an (e.g., each) insert link based on signal quality of the audio or video content and transcription certainty. The closed caption service application may conditionally apply the insert link when the confidence score exceeds a threshold and/or may flag the location for deferred review when the confidence score does not exceed the threshold. The confidence model may ingest acoustic features, speaker diarization changes, and/or language model perplexity to stabilize annotation decisions.

240 may include detecting, by the machine learning engine, a subtopic and/or a topic using hierarchical clustering of keyword embeddings. The closed caption service application may seed a second regular expression with an insert link specific to the subtopic that may apply a distinct adornment from the topic-level insert link. The system may maintain a topic stack per frame and/or may emit structural markers that may allow downstream viewers to collapse or expand subtopic ranges.

245 may include updating, by the closed caption service application, previously inserted annotations when the topic and/or subtopic changes. The closed caption service application may regenerate formatted strings that may combine original text and insert links, may reconcile conflicts among overlapping nodes by priority rules, and may preserve a change log with frame-level diffs. The closed caption service application may reindex structural elements, for example title headers and section headers, using the index identifier to keep navigation stable across revisions.

250 may include generating, by the closed caption service application, the annotated feed based on the insert link. The annotated feed may be, by the closed caption service application, streamed to client devices, may be stored for post-processing in a database, and may be exported with embedded indexes that may support search and analytics. The feed may include timestamps, text buffers, and/or lists of resolved insert links per frame and may expose an interface that may allow applications to query by topic, subtopic, color code, and/or rule application type.

255 may include partition processing by a server in communication with the closed caption service application. The server may partition processing across multiple processors and nodes, may queue segment jobs using backpressure informed by confidence computations, and may shard database access by vocabulary domain. The server may throttle adornment density to preserve readability and may enforce style guides retrieved through word links.

260 may include validating, by the closed caption service application, output quality. The closed caption service application may sample frames based on low confidence or high conflict counts, may surface recommended edits, and/or may incorporate accepted edits into rule sets stored in the database. The closed caption service application may incrementally improve topic selection thresholds and/or adornment policies using feedback signals.

265 may include synchronizing, by the closed caption service application, historical annotations. The closed caption service application may propagate topic and subtopic changes across previously persisted segments, may update hyperlinks and color codes consistently, and may maintain versioned snapshots that may be restored on demand. The system may deliver coherent, accurate, and visually structured transcripts that may reduce manual labor, may increase consistency, and may enable efficient navigation and analytics.

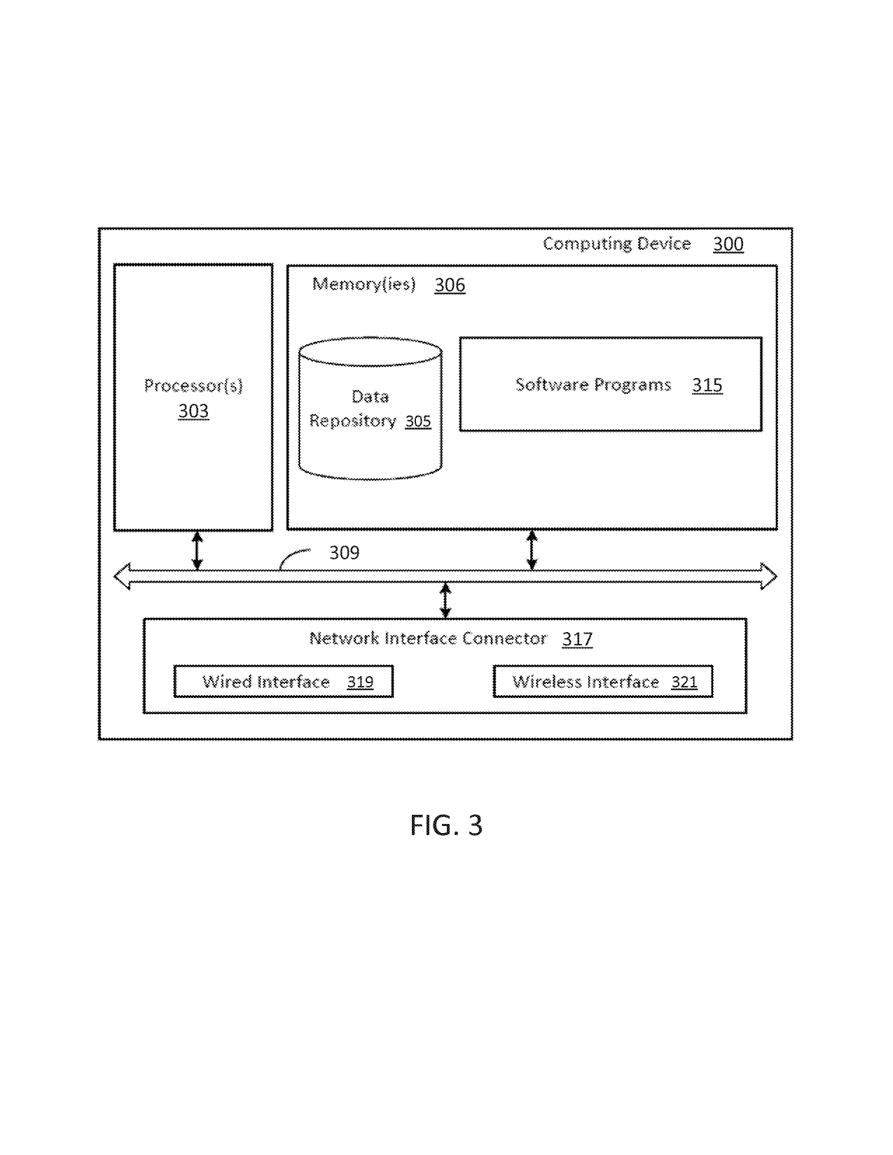

FIG. 3 is a block diagram of a computing device for implementing certain embodiments of the present disclosure. FIG. 3 depicts exemplary computing device 300. Computing device 300 may represent hardware that executes the logic that drives the various system components described herein. For example, system components such as a user device, an interface, an event streaming platform, a matching algorithm, and various database/data store engines and servers, and other computer applications and logic may include, and/or execute on, components and configurations like, or similar to, computing device 300.

Computing device 300 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which can be executed by processor 303. Memory 306 may include data repository 305, which may be nonvolatile memory for data persistence. The processor 303 and the memory 306 may be coupled by a bus 309. In some examples, the bus 309 may be coupled to one or more network interface connectors 317, such as wired network interface 319, and/or wireless network interface 321. Computing device 300 may have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” an “electronic device,” a “mobile device,” etc. These may be a computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above. Such a set of instructions for performing a particular task may be characterized herein as an application, computer application, program, software program, or simply software. In one aspect, the processing machine may be or include a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

The processing machine used to implement the invention may be a general-purpose computer. However, the processing machine described above may utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, a (e.g., each) processor and the memories used by the processing machine may be located in geographically distinct locations and connected so as to communicate in any suitable manner. Additionally, it is appreciated that a (e.g., each) processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might be in the form of a collection of separate programs, a program module within a larger program, or a portion of a program module, for example. The software used might include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

The instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while interacting partially with a human user.

It will be readily understood by those persons skilled in the art that the present invention is susceptible to broad utility and application. Many embodiments and adaptations of the present invention other than those herein described, as well as many variations, modifications, and equivalent arrangements, will be apparent from or reasonably suggested by the present invention and foregoing description thereof, without departing from the substance or scope of the invention.

In instances of this disclosure where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications, or equivalent arrangements.

1. A computer-implemented method for generating annotated transcript text, comprising:
receiving, by a closed caption service application executed by one or more processors, a audio content or a video content as a stream or batch file;
generating, by the closed caption service application, a closed caption feed from the audio content or the video content;
transmitting, by an application programming interface (“API”) service, portions of the closed caption feed to a machine learning engine;
determining, by the machine learning engine, a topic based on semantic similarity among located keywords in the portions of the closed caption feed;
conducting, by a word search module, a word lookup for a word or a phrase of the closed caption feed against a database;
generating, by an expression module, a word link to the database for the word or the phrase of the closed caption feed, the word link including an index identifier;
seeding, by the closed caption service application, a regular expression with an insert link associated with a related word or a related phrase determined using the topic; and
generating, by the closed caption service application, an annotated feed by applying the regular expression to the closed caption feed to insert an adornment linked by the insert link.

2. The method of claim 1, wherein the receiving comprises caching the audio content or the video content in contiguous segments of a predetermined duration and updating the closed caption feed on a segment boundary to support real-time processing.

3. The method of claim 1, wherein the determining of the topic comprises computing a semantic similarity score among at least four consecutive words grouped as a phrase and selecting the topic when the semantic similarity score exceeds a threshold.

4. The method of claim 1, further comprising correcting, by the machine learning engine, a transcription error detected in the closed caption feed by semantically searching a candidate replacement for a single word and separately for a multi-word phrase, and updating the annotated feed with a corrected text associated with the transcription error prior to seeding the regular expression.

5. The method of claim 1, wherein the generating of the word link comprises assigning, for the word or the phrase, a pointer to a record or portion of a record in the database, the record storing one or more of a definition, a synonym set, a topic identifier, a color code, and a hyperlink target.

6. The method of claim 1, wherein the insert link comprises a node in a linked list that encodes an adornment type, a start index, an end index, and a priority value, and wherein generating the annotated feed comprises resolving conflicts among overlapping nodes by applying the priority value.

7. The method of claim 1, wherein the adornment comprises one or more of a highlighting, an underline, an italic, a bold, a title formatting, a section header formatting, an insertion of an emoji, an insertion of an image, and an insertion of a hyperlink.

8. The method of claim 1, further comprising selecting, by the closed caption service application, a color palette progression to visually distinguish consecutive topics and subtopics, and applying the color palette to the adornment such that adjacent topics receive different color codes sequentially according to the color palette progression.

9. The method of claim 1, wherein the regular expression encodes a search pattern for matching a topic-specific phrase and replacing the matched phrase with a formatted string comprising an original text of the closed caption feed and the insert link, and wherein the formatted string is updated when the topic changes in subsequent segments of the closed caption feed.

10. The method of claim 1, further comprising updating a previously inserted annotation by replacing an acronym with an expanded phrase and optionally appending a parenthetical acronym, or converting a spelled-out number to a numeric representation, based on a rule set retrieved via the word link.

11. The method of claim 1, wherein the annotated feed is generated as a stream and comprises a sequence of frames, a frame of the sequence of frames including a timestamp, a text buffer, and a list of insert links applied to the text buffer, and wherein the closed caption service application revises insert links in prior frames when the machine learning engine updates the topic.

12. The method of claim 1, wherein the word lookup accesses an external database hosted in a cloud environment and a local cache, and further comprising synchronizing, by the word search module, the local cache with the external database based on a cache miss event for the closed caption feed.

13. The method of claim 1, further comprising detecting, by the machine learning engine, a subtopic within the topic using a hierarchical clustering of keyword embeddings, and seeding a second regular expression with an insert link specific to the subtopic, the insert link applying a distinct adornment from a topic-level insert link.

14. The method of claim 1, wherein the closed caption service application applies a spacing formatting and a header formatting to transform a phrase designated as a title header or a section header into a structural element in the annotated feed, and indexes the structural element via the index identifier.

15. The method of claim 1, further comprising computing, by the machine learning engine, a confidence score for an insert link based on signal quality of the audio content or the video content and transcription certainty, and conditionally applying the insert link to the annotated feed only when the confidence score exceeds a threshold, otherwise flagging the location for deferred review.
